(19) United States
(12) Patent Application Publication
(10) Pub. No.: US 2009/0276254 A1
(43) Pub. Date: Nov. 5, 2009

(54) COLOR FORMULATION SELECTION PROCESS

(75) Inventors: Geoffrey Bruce Anderson, Geelong (AU); Paul Galea, Greenvale (AU); Mark Spence, Princes Risborough (GB); Jon David Whitby, Avon Lake, OH (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/112,556

(22) Filed: Apr. 30, 2008

(51) Int. Cl. G06Q 50/00; G06Q 10/00; G06F 17/30

(52) U.S. Cl. 705/7; 707/104.1; 707/100; 707/E17.014

(57) ABSTRACT

A computer-implemented method of repairing a vehicle is disclosed. The method includes steps of estimating the cost of performing repairs to a damaged vehicle and determining a refinish paint formulation for refinishing a vehicle by conducting a computer-based search for a refinish paint formulation that best matches the vehicle's original finish prior to performing the repair work on the vehicle, where the repair work comprises performing any body work, mechanical systems work and/or electrical systems work and refinishing the vehicle.

### FIELD OF THE INVENTION

This invention relates to a method and system for determining a color formulation for refinishing a vehicle.

### BACKGROUND OF THE INVENTION

When a vehicle is designed, the vehicle paint has an original formulation that is specified for production, referred to as the prime formulation for that paint. However, the color of paint applied to vehicles in a manufacturing setting tends to vary. The variability can be observed both within a single production facility when the components of the paint composition change slightly between production runs. This is typically seen as a drift in paint color of vehicles manufactured at a particular production facility. In addition, even more significant differences in the paint color can be observed between vehicles manufactured at different production facilities of the same vehicle manufacturer. Each of the production facilities may receive a different lot for the paint components, including the pigments and other colorants that are added to the paint, thereby imparting differences in the paint color between production facilities.

When a vehicle undergoes repair, a repair paint is applied to the vehicle, which should match the original paint. However, due to color shifts in the original paint applied to vehicles during manufacturing, it is difficult to match the repair paint to the original paint. Differences between the original vehicle paint and a repair paint on the vehicle can be perceived. The color variations of paint produced by original equipment manufacturers are difficult to color match in the multitude of auto body repair shops that repaint vehicles.

Vehicles typically include a series of identification tags, including a color code that refers to the original paint formulation. Due to the paint color variation, each color code generally corresponds to a plurality of variant formulations that are associated with the prime formulation. Repair paint personnel must select the paint formulation from the plurality of formulations associated with a single color code that best matches the paint of the vehicle undergoing repair.

When a vehicle enters an auto body repair facility, an estimate for conducting the repair is prepared. The repair work includes body work on painted components (e.g., panels or bumpers) and often also involves repair of the vehicle's mechanical systems and electrical systems. The final step in a repair process is refinishing the exterior damaged portion of the vehicle. The paint repair involves obtaining a paint formulation that closely matches the color and color effect of the original vehicle paint. The process of determining the matching paint formulation does not occur until near the time that the vehicle is ready for refinishing, i.e., after the body work (and any mechanical/electrical systems work) is completed. By that time, the vehicle may already have been at the repair facility for several days or longer. Repair personnel are then tasked with rapidly identifying a closely matching refinish paint formulation. Any delays in attempting to identify a satisfactory paint formulation are often a source of delay in returning the vehicle to its owner. In addition, delays associated with refinish paint color matching at the end of the repair process are costly to the repair facility in terms of productivity (throughput) and associated expenses (such as insurance).

### SUMMARY OF THE INVENTION

The present invention is directed to a computer-implemented method of repairing a vehicle comprising: (1) prior to beginning repair work on a vehicle: (a) estimating the cost of performing repairs to a damaged vehicle; and (b) conducting a computer-based search to identify a refinish paint formulation that best matches the vehicle original finish; and (2) performing repair work on the vehicle, the repair work comprising refinishing the vehicle with the best matched refinish paint formulation identified in step (1).

The present invention also includes a computer-implemented method of identifying a refinish repair formulation comprising providing a computer having a database comprising refinish paint formulations associated with color data; entering color data for a vehicle to be repaired into the computer and searching for a refinish formulation in the database that best matches the vehicle color data; and identifying the best match refinish formulation and a match rating for the identified formulation.

The present invention further includes a computer-implemented method of repairing a vehicle comprising providing a computer having a database comprising refinish paint formulations associated with color data; entering color data for a vehicle to be repaired into the computer and searching for a refinish formulation in the database that best matches the vehicle color data; identifying the best match refinish formulation and a match rating for the identified formulation; and performing repair work on the vehicle, the repair work comprising refinishing the vehicle with the identified formulation, wherein the vehicle is refinished according to the match rating for identified formulation.

### BRIEF DESCRIPTION OF THE DRAWING

FIG. 1 is a flow chart of the method of the present invention.

### DETAILED DESCRIPTION OF THE INVENTION

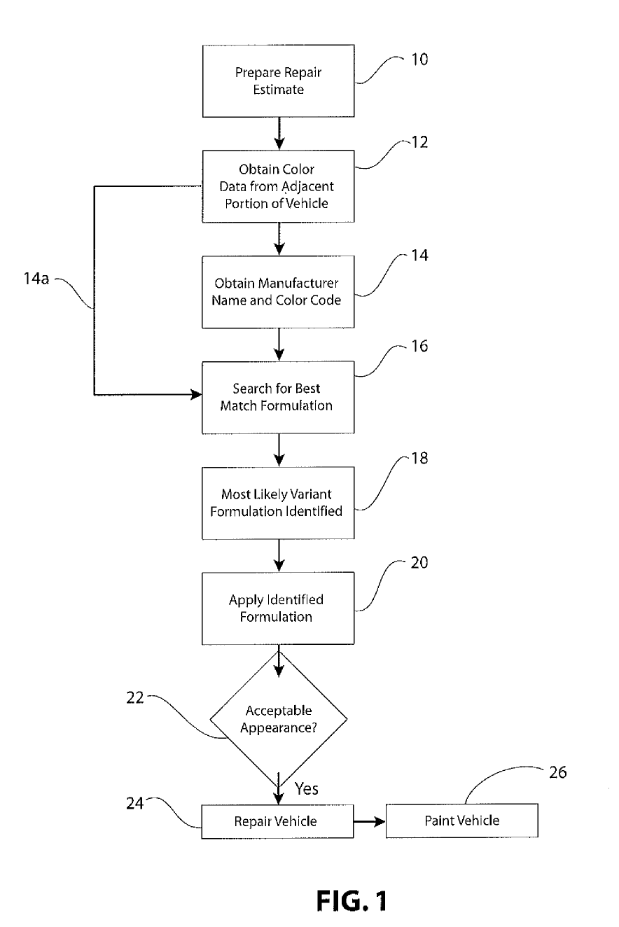

The present invention is described in relation to a method for selecting a color formulation during refinishing of a vehicle undergoing auto body repair. Referring to the flow chart appearing in FIG. 1 when a vehicle arrives at an auto body repair shop, an estimate of the cost and timing for repairing the vehicle is prepared at step 10. The cost estimate is prepared in order to provide an understanding of the scope of the work to be completed so that the vehicle owner can decide what work should be completed or so that an insurance company may be informed as to the cost that will be incurred during the repair process, or a combination of both. A highly accurate estimate results in a greater accuracy of the final cost to the vehicle owner and/or insurance company, both of which lead to satisfaction with the performance of the repair conducted by the autobody repair facility. Once the repair estimate has been accepted (by the vehicle owner and/or insurance company), the vehicle is processed through the repair facility. In the method of the present invention, after preparation of the repair estimate (step 10), a refinish paint formulation for refinishing the damaged body work of the vehicle undergoing repair is selected. It has been found that by performing the refinish formulation selection process well in advance of the actual physical repair of the vehicle, bottlenecks associated with color matching that normally are presented at the end of the repair process can be avoided or at least worked out during the time that the body work and any mechanical/electrical systems work is conducted. By identifying an appropriate refinish paint formulation early in the auto body repair process, when the vehicle is ready for refinishing, the refinish paint formulation may be ready for mixing and application. Moreover, the search for a best match refinish paint formulation may be conducted using some or all of the computer systems employed to generate the repair estimate.

In one embodiment of the invention, color data from a surface of an undamaged portion of a vehicle is obtained in step 12. This may be performed using a spectrophotometer that provides a measurement of the color characteristics of a painted surface in the form of reflectance data corresponding to the amount of light reflected from the painted surface at certain viewing angles and/or illumination angles. The viewing angles of color data measurement may all be in a single plane (in-plane) or they may be out-of-plane with respect to each other. Likewise, light illuminating the painted surface may directed at the painted surface at one angle or more than one angle, with the multiple angles of illumination being in-plane or out-of-plane. The present invention includes obtaining color data from the surface of the undamaged portion of a vehicle any combination of such illumination angles and measurement angles.

One common system for analyzing color of an object is to define the reflectance data in a color space, such as the CIE 1976 (L*c*h*) color space that is based on tristimulas values of color using the three primary colors (red, green, blue). The L*c*h* values represent brightness, chroma and hue, respectively. In one embodiment, the L*c*h* color data may be obtained from an undamaged portion of the vehicle at a plurality of viewing angles, such as five viewing angles in order to obtain an accurate color reading for the vehicle to be refinished. Such viewing angles may include the aspecular angles of 15°, 25°, 45°, 75° and 105° (or 110°). These aspecular angles are not meant to be limiting as different angles and/or other quantities of viewing angles may be employed.

The measured color data obtained via the spectrophotometer from the undamaged portion of the vehicle are transferred to a computer. Suitable systems for transferring the measured color data from a spectrophotometer to a computer include wireless communication, memory sticks or the like or data transfer to a remote server via the Internet. In one embodiment, the transfer may be conducted by docking the spectrophotometer into a receiver that is hardwired to a computer. In addition, by “computer” is meant any microprocessor based device, such as a desktop computer, laptop computer, a remote server or a handheld device, such as a cellular device or personal data assistant (PDA).

In step 14, the manufacturer's name and the color code for the paint applied to the vehicle are obtained and entered into the computer. The color code is typically provided on the vehicle, such as on the door jam or the like, in an alphanumeric format. The color code is input via an input device such as a keyboard or a wireless transfer device.

The computer includes software for conducting a match of the color data and color code (or of the color data alone) to refinish paint formulations maintained in a database of the computer, as described below. The database includes prime and variant formulations of refinish paint formulations that are associated with vehicle manufacturer color codes and color data. In step 16, a variant search is conducted for the best match for the paint formulation based on both the color data obtained in step 12 and the color code in step 14. When variant searching based on the color data and color code, the software in the computer limits the search to the prime formulation and variants thereof that are specifically associated with that color code. This increases the probability of special effect pigments (such as metallic and pearlescent effect pigments) of the identified paint formulation matching the size and type of the special effect pigments of the original vehicle paint. By “best match” or related phrases, it is meant that the identified refinish paint formulation, when applied to the vehicle, appears the same as (or cannot be discerned with the eye as differing from) the adjacent undamaged portion of the vehicle.

In the event that the color code is not available for the vehicle, step 14 may be omitted (as per route 14a) and a chromatic search is conducted based solely on the color data obtained from the vehicle. In a chromatic search, the software searches the entire database of color data without specific regard to the special effect pigments.

The output of the search on the computer is the most likely prime or variant formulation or a plurality of formulations that best match the color data for the color code or best match the color data regardless of color code. References to a matched refinish paint formulation or identified refinish paint formulation should be understood to include one or more of such formulation unless indicated to the contrary. The computer software contains algorithms for (1) searching one or more databases of refinish paint formulations having color codes in step 16 and (2) identifying the best matched refinish paint formulation in step 18. The best match is presented to the user (e.g. repair personnel) using a numeric value termed a “match rating”. The match rating represents a modified color difference. The software calculates the color difference of the undamaged portion of the vehicle to the color data of the many stored paint formulations in the database. The match rating may be multiplied by a factor of 10, so that it may be more easily interpreted by the repair personnel (for example, so that the number is an integer value rather than a decimal). The match rating may be calculated by various means using published color difference equations such as CIELAB DE or CMC DE. The color difference may be a simple average over a multiplicity of viewing angles or a weighted average over a multiplicity of viewing angles. The match rating may be further modified by calculating the difference in flop index using published equations. The match rating is used by the repair personnel to provide a confidence level of the best match offered by the software. In this manner, the identified refinish paint formulation may be applied to the vehicle according to the match rating for the formulation. For example, match ratings of a value less than 8 may be regarded as an excellent or “panel” match, e.g. a sufficiently good match that a panel may be repainted without blending. Match ratings greater than 8 but less than 15 may be regarded as a “blendable” match that may require blending of the paint from the panel being refinished to adjacent portions of the vehicle. These numeric values are not meant to be limiting, and other confidence levels for the best match maybe required when the vehicle paint has a solid color or a metallic/pearlescent color effect.

An output device in communication with the computer presents the best matched refinish paint formulation and match rating to the user, such as on a computer screen or printout or the like. The identified formula is mixed and applied to a test portion of the vehicle in step 20. If the applied formulation is acceptable, the remaining portion of the repair of the vehicle proceeds as planned and the vehicle is painted with the formulation upon completion of the body work repair and the repair of the mechanical/electrical systems.

It will be readily appreciated by those skilled in the art that modifications may be made to the invention without departing from the concepts disclosed in the forgoing description. Such modifications are to be considered as included within the following claims unless the claims, by their language, expressly state otherwise, Accordingly, the particular embodiments described in detail herein are illustrative only and are not limiting to the scope of the invention which is to be given the full breadth of the appended claims and any and all equivalents thereof.

The invention claimed is:

1. A computer-implemented method of repairing a vehicle comprising:
(1) prior to beginning repair work on a vehicle,
(a) estimating the cost of performing repairs to a damaged vehicle; and
(b) conducting a computer-based search to identify a refinish paint formulation that best matches the vehicle original finish; and
(2) performing repair work on the vehicle, the repair work comprising refinishing the vehicle with the best matched refinish paint formulation identified in step (1).

2. The method of claim 1, wherein said step of conducting a search for a refinish paint formulation comprises:
obtaining color data from a surface of an undamaged portion of the vehicle and entering the vehicle color data into the computer; and
conducting a search for a refinish formulation in a database of the computer, the database comprising refinish paint formulations associated with color data, to identify a refinish paint formulation that that best matches the vehicle color data.

3. The method of claim 2, wherein the database further comprises refinish paint formulations associated with color data and color codes and said step of conducting a search for a refinish paint formulation further comprises:
entering a color code for the original paint formulation of the vehicle into the computer; and
conducting a search for a refinish formulation in the database of the computer to identify a refinish paint formulation that best matches the vehicle color data and vehicle color code.

4. The method of claim 2, wherein the color data comprises reflectance data obtained from the surface of the undamaged portion of the vehicle.

5. The method of claim 4, wherein the reflectance data is obtained using a portable spectrophotometer.

6. The method of claim 5, wherein the reflectance data is obtained at a plurality of viewing angles.

7. The method of claim 6, wherein the reflectance data is obtained at five viewing angles.

8. The method of claim 5 where the reflectance data is obtained from illumination of the surface of the undamaged portion of the vehicle at one or more angles.

9. The method of claim 2 wherein said step of conducting a search to identify a refinish paint formulation that best matches the vehicle color data further comprises providing a match rating for the identified refinish paint formulation.

10. The method of claim 3 wherein said step of conducting a search to identify a refinish paint formulation that best matches the vehicle color data further comprises providing a match rating for the identified refinish paint formulation.

11. A computer-implemented method of identifying a refinish repair formulation comprising:
providing a computer having a database comprising refinish paint formulations associated with color data;
entering color data for a vehicle to be repaired into the computer and searching for a refinish formulation in the database that best matches the vehicle color data; and
identifying the best match refinish formulation and a match rating for the identified formulation.

12. The method of claim 11, wherein the database further comprises refinish paint formulations associated with color data and color codes and said method further comprises:
entering the color code for the original paint formulation of the vehicle into the computer and searching for a refinish formulation in the database that best matches the vehicle color data and vehicle color code.

13. The method of claim 11, wherein the vehicle color data comprises reflectance data obtained from a surface of the undamaged portion of the vehicle.

14. The method of claim 13, wherein the reflectance data is obtained using a portable spectrophotometer.

15. The method of claim 14, wherein the reflectance data is obtained at a plurality of viewing angles.

16. The method of claim 15, wherein the reflectance data is obtained at five viewing angles.

17. The method of claim 16 where the reflectance data is obtained from illumination of the surface of the undamaged portion of the vehicle at a plurality of angles.

18. A computer-implemented method of repairing a vehicle comprising:
providing a computer having a database comprising refinish paint formulations associated with color data;
entering color data for a vehicle to be repaired into the computer and searching for a refinish formulation in the database that best matches the vehicle color data;
identifying the best match refinish formulation and a match rating for the identified formulation; and
performing repair work on the vehicle, the repair work comprising refinishing the vehicle with the identified formulation, wherein the vehicle is refinished according to the match rating for identified formulation.

19. The method of claim 18, wherein the database further comprises refinish paint formulations associated with color data and color codes and said method further comprises:
entering a color code for the original paint formulation of the vehicle into the computer and searching for a refinish formulation in the database of the computer that best matches the vehicle color data and vehicle color code.

20. The method of claim 19, wherein the vehicle color data comprises reflectance data obtained from a surface of the undamaged portion of the vehicle.
